(19) United States
(12) Patent Application Publication
(10) Pub. No.: US 2009/0314280 A1
(43) Pub. Date: Dec. 24, 2009

(54) Apparatus and A Method for Solar Tracking and Concentration af Incident Solar Radiation for Power Generation

(76) Inventor: Rajarshi Banerjee, San Jose, CA (US)

Correspondence Address: Rajarshi banerjee, 4441 lanes End Ct., San Jose, CA, 95121, US

(21) Appl. No.: 12/488,289

(22) Filed: Jun. 19, 2009

Related U.S. Application Data
(60) Provisional application No. 61/132,995, filed on Jun. 24, 2008.

(51) Int. Cl. F24J 2/10; F24J 2/38; B23P 11/00

(52) U.S. Cl. 126/606; 126/696; 29/428

(57) ABSTRACT

A method and an apparatus are presented for solar tracking and concentration of incident solar radiation for power generation. The apparatus includes a solar tracking system, an optical concentrator system and a radiation collection device. The solar tracking system includes a right ascension track and a declination track for dual axis solar tracking along equatorial coordinates of the sun, wherein the right ascension track and the declination track are driven at their respective rims. The optical concentrator system is moved by the solar tracking system to concentrate the incident solar radiation into a stationary focal point. The radiation collection device couples concentrated incident solar radiation to a power generation means. The radiation collection device is disposed proximate the stationary focal point to collect the incident solar radiation.

### CROSS-REFERENCE TO RELATED APPLICATIONS

The present Utility patent application claims priority benefit of the U.S. provisional application for patent Ser. No. 61/132,995 filed on Jun. 24, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to solar power generation technology. More particularly, the invention relates to a solar concentrating and solar tracking apparatus that is useful for solar power generation. The apparatus of the present invention can also be used for solar heating and heat storage applications that benefit from a stationary hot spot. The apparatus of the present invention is useful for the production of usable electrical or thermal energy from incident solar radiation.

### BACKGROUND OF THE INVENTION

Fossil fuels are a limited resource and their use has a negative impact on the environment. As a result of this, renewable sources of energy and means of harnessing them are acquiring increasing significance today. Solar energy is one of the major renewable energy resources and is available throughout the world. Currently, means of harnessing solar power are not cost competitive when compared with conventional sources of energy and there is an increasing effort to bridge the gap.

Solar power generation technologies can be grouped into two broad categories based on the principle utilized for conversion of solar energy. They are photovoltaic systems and thermal-electromechanical or simply thermal systems. The primary methods for increasing the output of these systems are solar tracking and optical concentration of solar radiation. Dual axis tracking can result in an improvement of 40% of daily power output as compared to a stationary photovoltaic panel. It is possible to increase the output still further by concentrating solar radiation into the surface of the panel from an area of incidence that is much larger than the surface of the panel.

Unlike photovoltaic systems, thermal systems require some form of solar tracking and concentration for power generation, otherwise they are limited to just passive heating. Examples of thermal systems are parabolic troughs wherein sunlight is focused by means of parabolic trough reflectors to heat a fluid which is circulated through a linear tube. Another example comprises a heliostat field array where an array of reflectors, spread over a large area, reflect solar radiation to a single, stationary location, which is usually a central receiving tower. These are often described simply as heliostats or power towers.

These systems suffer from non-optimal geometries wherein tracking and concentration are not fully realized resulting in energy losses inherent in the design, which are thus unavoidable. Examples of these losses are optical losses such as cosine and spillage losses as well as thermal losses. Lower overall efficiency also results in inefficient land usage, making these systems unsuitable where land is at a premium. It is therefore an objective of the present invention to provide efficient solar power generation systems with geometries that minimize energy losses.

Although the term heliostat has become synonymous with systems comprising arrays of reflectors that converge solar radiation to a fixed location, it is used herein in this discussion in its generic sense to connote any configuration of reflectors whether a single unit or an array, that converge and focus solar radiation to a fixed location with respect to the earth.

For both thermal and photovoltaic systems, the highest output and efficiencies are realized when solar radiation tracking and concentration are fully implemented and are closest to an ideal geometrical configuration. Examples of these high output systems are concentrating photovoltaic (CPV) systems and Dish-Stirling or more generally Dish-Thermal systems both of which implement dual axis tracking using a single standalone concentrating system that provides concentrated solar radiation to a single dedicated solar flux receiving and energy generation apparatus, which converts solar energy into usable power. In CPV systems sunlight is concentrated on to the surface of a high efficiency, multi-junction cell. In Dish-Stirling systems, the sunlight is focused usually by means of a parabolic reflector to the heat source of a Stirling engine. Both CPV systems and Dish-Stirling systems have achieved efficiencies exceeding 30%, the highest among all competing technologies. These systems also enable a relatively uniform power output through the day as compared to other systems. This can be attributed both to optimal tracking and concentration and also to the high efficiency of Stirling engines and multi-junction cells that are able to take advantage of highly concentrated sunlight.

However, the high efficiency and output of these systems come at a high cost of the tracking, concentrating and power generation apparatus as well as associated engineering challenges that increase capital and operational costs still further. Particularly in Dish-Thermal systems, a large component of these costs can be attributed to some common characteristics of related prior art and actual systems.

One such characteristic is a non-heliostat configuration described as a system that has a dynamic or moving point of convergence or focus of solar radiation. In a non-heliostat configuration, the solar flux receiving and energy generation apparatus moves along with the point of focus which describes large arcs as the sun is tracked through the day and seasons. Several limitations that derive from having a moving point of focus are apparent in prior art. One of these limitations is the constraints placed on the dimensions, weight and design of the flux receiving and power generation devices that can limit their efficiency. Another limitation is asymmetric loading or efforts to counter it by configurations where the mass of the apparatus is distributed over a large range of radii resulting in high moment of inertia and high stopping and starting torque requirements from the motors that actuate tracking motion. In addition to this, the tracking support structures need to support a large combined mass of the concentrator and power generation apparatus that can result in structural distortion and optical alignment inaccuracies. An additional limitation to consider in the above art is the vibration loading of the support structures since Stirling engines operate at high RPM. Yet another limitation of the above art, which is a function of having a moving receiver, is that the devices cannot be easily integrated with a cooling apparatus or with hybrid systems that have centralized power generation and heat storage devices that are fixed to the ground. All these factors entail high costs for the motors, the support structures and the concentrator. It is therefore an objective of the present invention to provide a solar power generation system with a stationary point of convergence or focus.

Another characteristic of such systems is the combination of an axial drive and a large radial spread of its mass resulting in high moment of inertia of the apparatus, wherein a drive motor typically actuates rotary motion in the apparatus by means of a drive shaft that is coupled to the apparatus either at, or in close proximity to the axis of rotation of the tracking apparatus and away from the average radius weighted by its mass. The high moment of inertia of the apparatus cannot be avoided because the concentrator needs to have a large aerial and radial spread to collect solar radiation; however, this limitation is heightened due to a majority of the designs implementing axial drives as mentioned. In such systems, additional structures for high gear reduction and indirect drives are often required and the accuracy and overall torque, particularly starting and stopping torque required of the motors are also high, which entails high cost. It is therefore an objective of the present invention to provide a solar power generation system incorporating a non-axial drive.

Yet another characteristic that drives costs and limitations is the usage of altitude-azimuth coordinates. Altitude-azimuth systems require either sensor based closed loop systems or complex open loop systems or a combination of both, to track the sun. Closed loop systems cannot track when clouds cover the sun. Open loop systems are overly complex due to the non-uniform motion of the sun along altitude and azimuth axes which require the coordinates to be computed at all times by solving ephemeris equations and often still require additional means for correction of step, drift and structural distortion errors. Both closed and open loop systems for altitude-azimuth trackers are expensive, require high maintenance, high precision motors and means of controlling step and drift errors because the motors need to step through non-uniform increments associated with altitude and azimuth tracking, necessitating high motor step rates combined with minute step magnitudes. Furthermore, altitude-azimuth based tracking systems exclude the possibility of decoupling the diurnal and seasonal tracking of the sun. It is therefore an objective of the present invention to provide a solar power generation system that does not use altitude-azimuth coordinates for tracking.

Stationary focus or heliostat Dish-Stirling systems are disclosed in the prior art. Some of these prior art systems implement altitude and azimuth of which the associated limitations are discussed above. Other prior art systems implement equatorial tracking, which is an alternate tracking method to altitude and azimuth; however these apparatuses implement axial drives and their mass has a large radial spread with respect to the axis of rotation. Such systems also afford very limited scope for incorporating large gear reduction assemblies and lowering mechanical advantage.

Another arrangement for achieving a stationary focus/heliostat configuration along with equatorial tracking that is well understood to those skilled in the prior art comprises nested gimbals that support the concentrator allowing it two degrees of freedom. However, this design implements axial drive systems and in general all gimbal-based designs afford very limited scope for the incorporation of large gear reduction assemblies. This entails low mechanical advantage and the use of a larger amount of structural material.

Yet another stationary focus design which has been deployed in several parts of the world for solar cooking and heating applications, achieves a fixed focus by implementing single axis right ascension tracking and varying the curvature of a flexible mirror for declination tracking. The performance of this system is inferior to systems with rigid mirrors and true dual axis tracking, primarily because the region in space where sunlight is concentrated varies with the change in the curvature of the reflector.

Another system known in the prior art is a device that is able to achieve a stationary focus and is compatible with non-axial rim drives. However, this system implements altitude and azimuth based solar tracking and uses a large amount of material for the construction of the tracking apparatus and associated support structures.

In view of the foregoing, there is a need for improved techniques for providing a method and apparatus for the dual-axis tracking and concentration of incident solar radiation for power generation that has a stationary focal point and a non-axial drive and does not use altitude and azimuth tracking.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1 through 5 illustrate an exemplary solar radiation tracking and concentration apparatus for a solar power generation system, in accordance with an embodiment of the present invention;

FIG. 1 is a top perspective view of the apparatus, in accordance with an embodiment of the present invention;

FIG. 2 is a lateral view of an exemplary optical concentrator and right ascension system, in accordance with an embodiment of the apparatus of the present invention;

FIG. 2A is a cross sectional view of section XX of FIG. 2 illustrating the cross section of an exemplary right ascension track and a right ascension guide, in accordance with an embodiment of the present invention. It is to be noted that the cross section of the right ascension motor and worm shaft are not depicted in this figure;

FIG. 2B is a magnified view of the rim of an exemplary right ascension track showing a motor shaft and a worm gear profile, in accordance with an embodiment of the present invention;

FIG. 3 is a lateral view of an exemplary declination system, in accordance with an embodiment of the present invention;

FIG. 3A is a cross sectional view of section XX of FIG. 3 illustrating the cross section of an exemplary declination track and declination guide, in accordance with an embodiment of the present invention. It is to be noted that the cross section of the right ascension motor and worm shaft are not depicted in this figure;

FIG. 3B is a magnified view of the rim of an exemplary declination track showing the motor shaft and the worm gear, in accordance with an embodiment of the present invention;

FIG. 4 is a top view of an exemplary tracking system apparatus without an optical concentrator, in accordance with an embodiment of the present invention; and

FIG. 5 is a perspective view of an exemplary tracking system apparatus showing a right ascension plane and axis, a declination plane and axis, north and south cardinal directions, and the path of incident and converging solar radiation, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus and a method for solar tracking and concentration of incident solar radiation for power generation is presented.

In one embodiment an apparatus for solar tracking and concentration of incident solar radiation for power generation is presented. The apparatus includes means for dual axis solar tracking along equatorial coordinates of a sun, using rim driven tracks, means for concentrating the incident solar radiation into a stationary focal point, wherein the concentrating means is moved by the dual axis solar tracking means and means for coupling concentrated incident solar radiation to a power generation means. Another embodiment further includes means for guiding the rim driven tracks. Yet another embodiment further includes means for driving the rim driven tracks.

In another embodiment an apparatus for solar tracking and concentration of incident solar radiation for power generation is presented. The apparatus includes a solar tracking system for dual axis solar tracking along equatorial coordinates of a sun. The solar tracking system including a right ascension track having a rim and a declination track having a rim, wherein the right ascension track and the declination track are driven at their respective rims. An optical concentrator system concentrates the incident solar radiation into a stationary focal point, wherein the optical concentrator system is moved by the solar tracking system and the stationary focal point remains in a substantially fixed spatial location. A radiation collection device couples concentrated incident solar radiation to a power generation means. The radiation collection device is disposed proximate the stationary focal point to collect the incident solar radiation. In another embodiment the optical concentrator system is joined to the right ascension track. In yet another embodiment the right ascension track forms an ascension arc with a center of curvature at the stationary focal point and the declination track forms a declination arc with a center of curvature at the stationary focal point. Still another embodiment further includes a right ascension guide supporting the right ascension track and a declination guide supporting the declination track, wherein the right ascension guide is joined to the declination track. In another embodiment the right ascension track further including plurality of gear teeth for engaging worm shaft to drive the right ascension track for rotating the right ascension track in a right ascension plane. In yet another embodiment the declination track further including plurality of gear teeth for engaging worm shaft to drive the declination track for rotating the declination track in a declination plane. In still another embodiment the right ascension track rotates about a right ascension axis, the declination track rotates about a declination axis, and the right ascension axis and the declination axis are perpendicular to each other and intersect within the stationary focal point. In another embodiment the right ascension track forms an arc of at least 180 degrees and the right ascension track further includes a partial annular disc with flanges on both of its flat surfaces, and a circular guide rail on both curved surfaces of the flange. In yet another embodiment the right ascension guide includes two parallel flat plates with pairs of wheels for engaging with the circular guide rails of the right ascension track. In still another embodiment the declination track further includes a partial annular disc with flanges on both of its flat surfaces, and a circular guide rail on both curved surfaces of the flange. In another embodiment the declination guide includes two parallel flat plates with pairs of wheels for engaging with the circular guide rails of the declination track. In yet another embodiment the radiation collection device couples heat to a power generator. In still another embodiment the radiation collection device couples concentrated incident solar radiation to a photovoltaic cell array. In yet another embodiment the radiation collection device reflects concentrated incident solar radiation to a fixed location in space.

In another embodiment a method for solar tracking and concentration of incident solar radiation for power generation is presented. The method includes the steps of tracking a sun with a solar tracking system including a right ascension track having a rim and a declination track having a rim for dual axis solar tracking along equatorial coordinates of the sun, wherein the right ascension track and the declination track are driven at their respective rims during the tracking. The method includes moving an optical concentrator system to concentrate the incident solar radiation into a stationary focal point, wherein the optical concentrator system is moved by the solar tracking system. The method includes collecting concentrated incident solar radiation with a radiation collection device disposed proximate the stationary focal point and coupling concentrated incident solar radiation to a power generation means. In yet another embodiment the coupling couples heat to a power generator. In still another embodiment the coupling couples concentrated incident solar radiation to a photovoltaic cell array. In another embodiment a method for making a solar tracking and concentration of incident solar radiation for power generation is presented. The method comprises providing the said solar tracking system, providing the said optical concentrator system and providing the said radiation collection device. Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In view of the limitations in the prior art discussed in the prior sections, the present invention provides a new device that seeks to overcome them.

Preferred embodiments of the present invention seek to implement a solar radiation collection apparatus where the focal point of convergence of solar radiation is stationary thereby eliminating many of the limitations associated with systems that have a non-stationary focal point.

Preferred embodiments of the present invention seek to implement a high mechanical advantage, low torque tracking drive system. This is implemented by actuating rotary motion of the apparatus not at the axis of rotation but at a location close to the average radius of the apparatus weighted by its mass, usually near the rim. For brevity such an idealized system is referred to herein as “a rim driven system”.

Preferred embodiments of the present invention also seek to implement dual axis, equatorial solar tracking, thereby eliminating most of the issues associated with altitude-azimuth tracking.

According to a preferred embodiment of the present invention, an apparatus can be used for solar tracking and concentration of incident solar radiation for power generation. The apparatus comprises a solar tracking system, an optical concentrator system and a radiation collection device. The solar tracking system comprises a right ascension track and a declination track for dual axis solar tracking along equatorial coordinates of the sun, wherein the right ascension track and the declination track are driven at their respective rims. The optical concentrator system is moved by the solar tracking system to concentrate the incident solar radiation into a stationary focal point. The radiation collection device is located at the stationary focal point, wherein the radiation collection device is capable of being independently supported without any mechanical linkage with the solar tracking system and the optical concentrator system. The radiation collection device is coupled to a power generation device.

Preferred embodiments of the present invention provide a method for solar tracking and concentration of incident solar radiation for power generation. The method comprises tracking of the sun by the said solar tracking system, moving the said optical concentrator system by the solar tracking system and collecting the solar radiation by the said radiation collection device. Preferred embodiments of the present invention also provide a method of making an apparatus for solar tracking and concentration of incident solar radiation for power generation. The method comprises providing the said solar tracking system, providing the said optical concentrator system and providing the said radiation collection device.

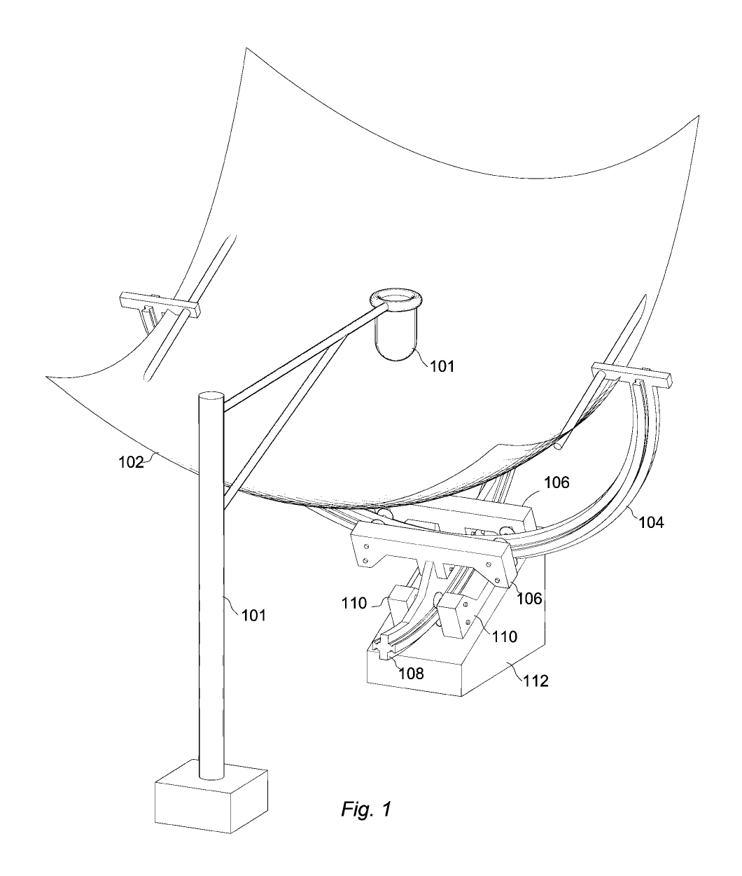

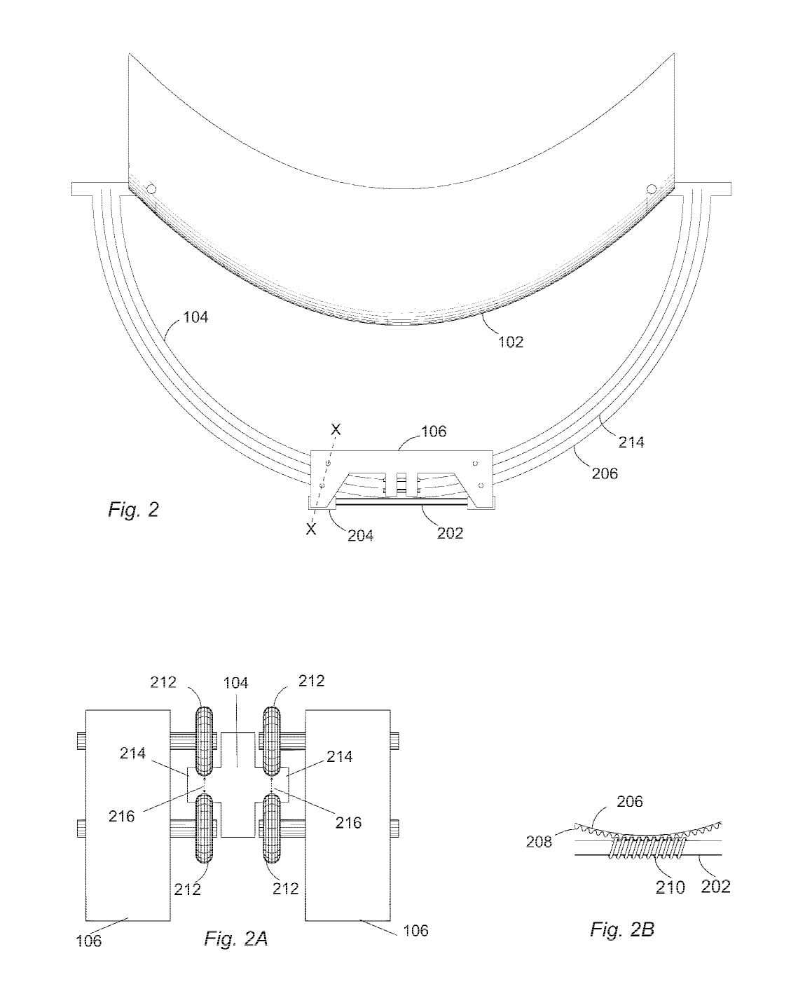

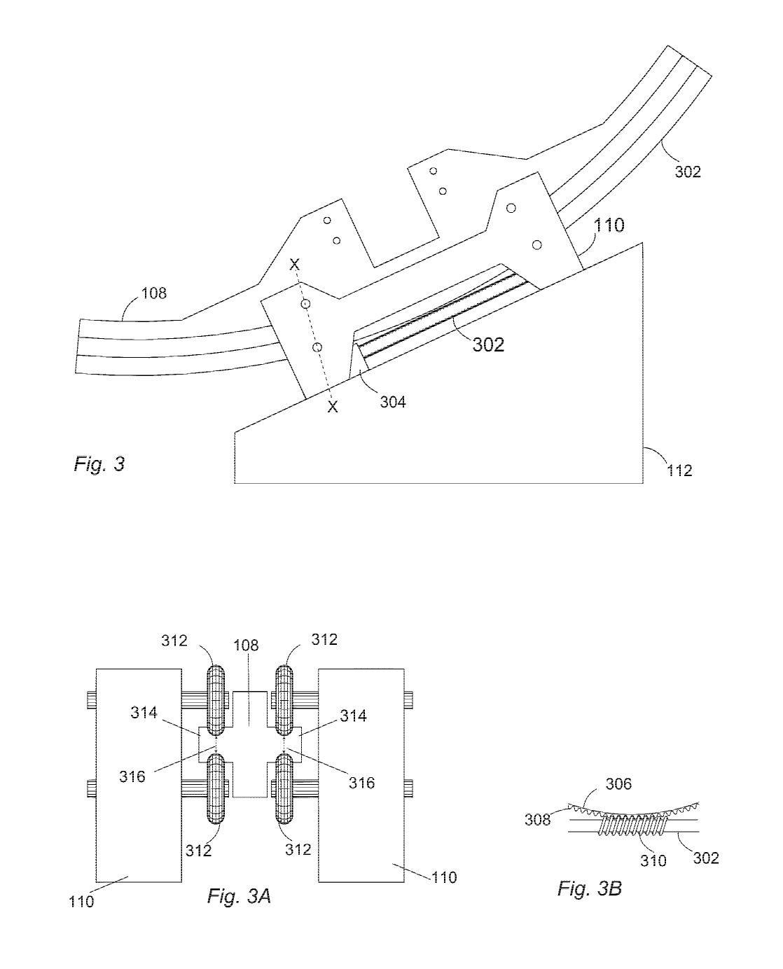

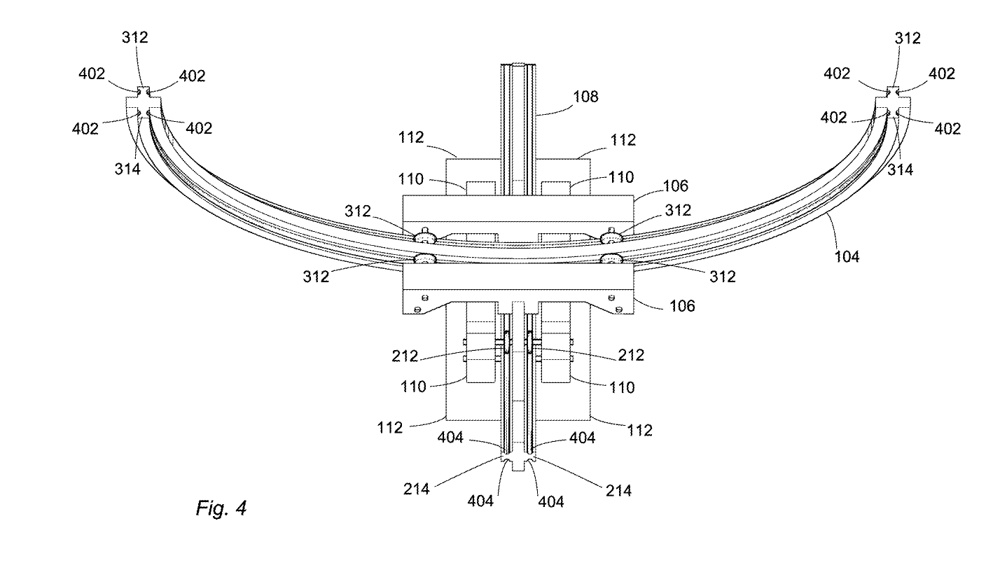

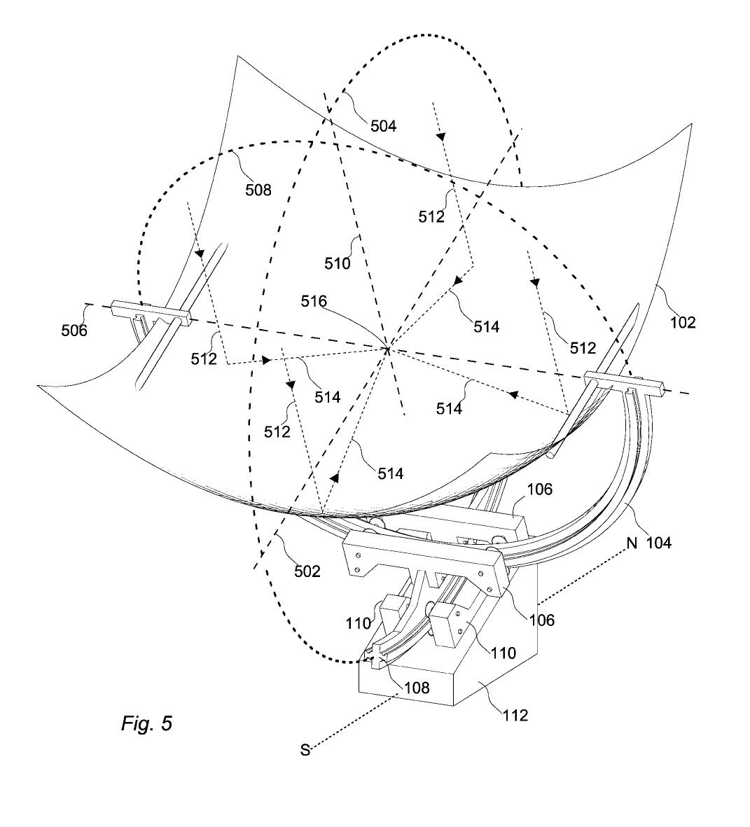

FIGS. 1 through 5 illustrate an exemplary solar radiation tracking and concentration apparatus for a solar power generation system, in accordance with an embodiment of the present invention. FIG. 1 is a top perspective view of the apparatus. FIG. 2 is a lateral view of an exemplary optical concentrator 102 and right ascension system, in accordance with an embodiment of the apparatus of the present invention. FIG. 2A is a cross sectional view of section XX of FIG. 2 illustrating the cross section of an exemplary right ascension track 104 and a right ascension guide 106. It is to be noted that the cross section of a right ascension motor 204 and a worm shaft 202 are not depicted in this figure. FIG. 2B is a magnified view of the rim of exemplary right ascension track 104 showing exemplary worm shaft 202 and a worm gear profile 210. FIG. 3 is a lateral view of an exemplary declination system, in accordance with an embodiment of the present invention. FIG. 3A is a cross sectional view of section XX of FIG. 3 illustrating the cross section of an exemplary declination track 108 and a declination guide 110. It is to be noted that the cross section of a declination motor 304 and a worm shaft 302 are not depicted in this figure. FIG. 3B is a magnified view of the rim of exemplary declination track 108 showing exemplary motor worm shaft 302 and worm gear profile 310. FIG. 4 is a top view of an exemplary tracking system apparatus without optical concentrator 102, in accordance with an embodiment of the present invention; and FIG. 5 is a perspective view of an exemplary tracking system apparatus showing a right ascension plane 504 and a right ascension axis 502, a declination plane 508 and a declination axis 506, north and south cardinal directions, and exemplary paths 512 and 514 of incident and converging solar radiation, in accordance with an embodiment of the present invention.

In the present embodiment, optical concentrator 102, which is embodied as a single parabolic reflector, collects and focuses solar energy and is mounted on right ascension track 104 preferably embodied as a partial annular disc. In alternate embodiments the optical concentrators may have various different shapes such as, but not limited to, hemispheres, cones, pyramids, etc. and can also comprise a collection of reflecting or refracting Fresnel elements that incorporate these aforementioned shapes and converge incident solar radiation to common focal point 516. Referring to FIGS. 2, 2A and 4, right ascension track 104 in the present embodiment comprises symmetric flanges 214 on both of its flat surfaces. Each flange 214 comprises two curved surfaces with a circular guide rail 402 on each of these curved surfaces. Right ascension track 104 also comprises worm gear teeth 208 on an outer convex circular rim 206 shown in FIG. 2B. Right ascension track 104 supports optical concentrator 102 and tracks the sun along its right ascension coordinates by rotating around the center of curvature of right ascension track 104 while being constrained by right ascension guide 106. In the present embodiment, the partial annular disc that embodies right ascension track 104 describes an arc of at least 180 degrees as shown by way of example in FIG. 2 which is required to track the daily motion of the sun from sunrise to sunset.

In the present embodiment, right ascension guide 106 comprises two parallel flat plates arranged symmetrically on either side of right ascension track 104. Each of these plates has at least two pairs of guide wheels 212 as shown by way of example in FIG. 2A. Wheels 212 engage with circular guide rails 402 of flange 214 as shown by way of example in FIGS. 2A and 4. The pairs of guide wheels 212 have a separation 216 between them that just allow free passage of the facing flange 214. The rims of guide wheels 212 have a convex cross sectional profile that engage circular guide rails 402 embodied as concave semicircular grooves. The exact fit between wheels 212 and the surfaces of guide rails 402 generally ensures that the motion of right ascension track 104 is constrained so as to rotate about axis of curvature 502 of right ascension track 104. Apart from constraining the motion of right ascension track 104, right ascension guide 106 and right ascension guide wheels 212 also support right ascension track 104. Those skilled in the art, in light of the present teachings, will readily recognize that means other than guide wheels and guide rails may be used in alternate embodiments to constrain and guide the motion of the right ascension track such as, but not limited to, guide wheels and guide rails of different configurations, slides on guide rails, pins in slots, bearings, etc. In the present embodiment, right ascension guide 106 is fixed to declination track 108 and is also supported by declination track 108.

Fixed to right ascension guide 106 is right ascension motor 204. Worm shaft 202 is coupled to right ascension motor 204 and engages with worm gear teeth 208 on the convex circular rim 206 of right ascension track 104. Right ascension motor 204 actuates rotary motion of right ascension track 104 by means of worm shaft 202, such that each rotation of worm shaft 202 corresponds to a fractional rotation of right ascension track 104.

Referring to FIGS. 3, 3A and 4, declination track 108 comprises symmetric flanges 314 on both of its flat surfaces. Each flange 314 has two curved surfaces with a circular guide rail 404 on each of these curved surfaces. Declination track 108 also comprises worm gear teeth 308 on its outer convex circular rim 306 as shown in FIG. 3B. Declination track 108 supports right ascension guide 106 and also tracks the sun along its declination coordinates by rotating around declination axis 506 while being constrained by declination guide 108. The partial annular disc that embodies declination track 108 describes an arc of at least 57 degrees as shown by way of example in FIG. 3, which is required to track the seasonal motion of the sun from the summer solstice to the winter solstice.

In the present embodiment, declination guide 110 comprises two parallel flat plates arranged symmetrically on either side of declination track 108. Each of these plates has at least two pairs of guide wheels 312 as shown by way of example in FIG. 3A. Wheels 312 engage with circular guide rails 404 of flange 314 as shown by way of example in FIGS. 3A and 4. The pairs of guide wheels 312 have a separation 316 between them that just allow free passage of facing flange 314. Rims of guide wheels 312 have a convex cross sectional profile that engage circular guide rails 404 embodied as concave semicircular grooves. The exact fit between wheels 312 and guide rails 404 generally ensure that the motion of declination track 108 is constrained so as to rotate about declination axis 506. Apart from constraining the motion of declination track 108, declination guide 110 and declination guide wheels 312 also support declination track 108. Those skilled in the art, in light of the present teachings, will readily recognize that means other than guide wheels and guide rails may be used in alternate embodiments to constrain and guide the motion of the declination track such as, but not limited to, guide wheels and guide rails of different configurations, slides on guide rails, bearings, pins in slots, etc. In the present embodiment, declination guide 110 is fixed to a platform 112 with an inclined plane; however, in alternate embodiments the declination guide may be fixed to other surfaces such as, but not limited to a platform with a flat plane, the ground, a roof, etc.

In the present embodiment, declination motor 304 is fixed to declination guide 110. Worm shaft 302 is coupled to declination motor 304 and engages with worm gear teeth 308 on convex circular rim 306 of declination track 108. Declination motor 304 actuates rotary motion of declination track 104 by means of worm shaft 302 such that each rotation of worm shaft 302 corresponds to a fractional rotation of declination track 108.

Referring to FIG. 5 in the present embodiment, the configuration of optical concentrator 102, right ascension track 104, right ascension guide 106, declination track 108, and declination guide 110 is such that the centers of curvature of the respective circular guide rails 402 and 404 of right ascension track 104 and declination track 106 coincide with each other and also coincide with a stationary focal point 516 of optical concentrator 102 and also such that right ascension axis 502 and declination axis 506 are mutually perpendicular and intersect at focal point 516.

The apparatus is polar-aligned in a manner wherein declination plane 508, is vertical, aligned in a north-south direction and coincides with the solar declination plane such that its mean orientation is aligned with the equinoctial solar declination. The arrangement can be realized by mounting the apparatus on a south facing inclined plane in the northern hemisphere or a north facing plane in the southern hemisphere whose inclination angle matches the mean solar declination or the latitude of the geographical location. Right ascension plane 504 coincides with the solar right ascension plane.

The configuration and alignment described above enables declination track 108 to rotate in declination plane 508 and about declination axis 506 so as to track solar declination and also enables right ascension track 104 to rotate in right ascension plane 504 about right ascension axis 502, thereby constituting a polar-aligned, dual axis, equatorial solar tracking system. Paths 512 and 514 illustrate the direction of incident and converging solar radiation, respectively. Because of the tracking system of the present embodiment, incident solar radiation hits optical concentrator 102 perpendicularly as shown by way of example by paths 512 and is then reflected by optical concentrator 102 along paths 514 to converge at stationary focal point 516.

Referring to FIG. 1 in the present embodiment, a solar radiation collection device 101 is placed at or near stationary focal point 516 of optical concentrator 102. Solar radiation collection device 101 is preferably independently supported without any mechanical linkage to the solar tracking system or to optical concentrator 102. However, in alternate embodiments the radiation collection device may be attached to the solar tracking system or to the optical concentrator so that the collection device is positioned at the stationary focal point. In the present embodiment, radiation collection device 101 may be the heat source of a heat engine that converts incident thermal energy to electrical power, a photovoltaic device that generates electrical power from incident solar radiation or a thermoelectric device that coverts heat to electricity utilizing the peltier effect. Alternatively, a heat exchanger or a heat storage device can be placed at stationary focal point 516 to aggregate and store thermal energy and supply this thermal energy to other devices. In addition to this material to be heated as in a furnace, cooking apparatus, pyrolysis chamber or an endothermic reaction chamber etc. can be placed at or near focal point 516 utilizing the stationary hotspot produced by converging solar radiation. Also in addition to this means of collecting guiding and distributing concentrated solar radiation can be placed at focal point 516 for the purposes of illumination of enclosed spaces such as the interiors of buildings.

The efficiencies of the power generation apparatus of the present embodiment can be enhanced by circulating coolants to any heat sinks. For thermal systems, circulating a heated fluid from focal point 516 to the heat source of a heat engine or heat storage device provides opportunities for scaling up or integration with hybrid thermal power generation systems and heat storage apparatuses. In the present embodiment, fluids such as, but not limited to, water, oil, steam, or a fused salt mixture can easily be circulated from solar radiation collection device 101 to power generation or heat storage devices without requiring flexible joints and tubes.

The present embodiment also enables additional means of scaling up by arranging multiple concentrators in arrays and by the placement of a secondary reflector close to primary focal point 516 that can focus radiation from each concentrator in the array to a central receiving location. In this type of configuration, the motion required of the secondary reflectors is a simple function of the declination and right ascension coordinates and can also be controlled by simple clock controlled drives. The efficiency of such a system would be higher compared to conventional arrays, since thermal, cosine and spillage losses would be small and power output would be more uniform through the day. Overall land usage would thus be reduced, making the system viable even in small-scale deployments or micro-grids, which can be important in situations where capital costs for land and power transmission infrastructure are high.

In typical use of the present embodiment, the tracking apparatus comprising right ascension track 104, declination track 108, right ascension guide 106, declination guide 110, and optical concentrator 102 is configured in a manner to track the sun along solar right ascension and declination coordinates so as to converge incident solar radiation to stationary focal point 516. The heat source of a heat engine such as, but not limited to, a Stirling engine or a thermoelectric device is placed at focal point 516 so as to collect incident solar thermal energy and direct it to the heat engine which coverts it to usable electrical energy. Alternatively, a diffuser can be used to direct the converging incident solar radiation onto the surface of concentrating photovoltaic devices that convert the solar radiation into usable electrical energy. In alternate implementations, a thermoelectric device may be used in certain applications where, given current specifications, are not very sensitive to cost or efficiency. A generic representation of a solar radiation collection device 101 is shown by way of example in FIG. 1 which does not depict the actual specific forms and functions of such devices. Those skilled in the art, in light of the present teachings, will readily recognize that a multiplicity of different types of collection devices may be used in alternate embodiments of the present invention including, but not limited to, devices to store or use thermal energy or devices that utilize the photoelectric or thermoelectric effects or devices that collect and redistribute sunlight for the purposes of illumination.

In many applications it may be preferable to have specular light/radiation converging on collection device 101 where the axis of symmetry 510 of the converging cone of light/radiation is parallel to the axis of rotational symmetry of collection device 101. This can be achieved by pivoting collection device 101 in a gimbal mechanism, so that the orientation of collection device 101 with respect to optical concentrator 102 is fixed without transferring weight to the tracking apparatus or optical concentrator 102 since collection device 101 is independently supported in the present embodiment. This can also be achieved in alternate embodiments by fixing the collection device to the optical concentrator in this position.

In an alternate embodiment, a secondary mirror can be placed near the stationary focal point that can be rotated as the tracker moves so as to always shine a near specular converging or collimated beam to a fixed point in space such as, but not limited to, a power tower. To achieve this, the secondary mirror can be constrained such that its normal always bisects the angle subtended by the axis of symmetry 510 of converging rays 514 emanating from the primary concentrator 102 and the line between the primary focal point and the final receiving location. This can be attained by a simple clock based control since the motion is a simple function of the solar declination and right ascension, which vary uniformly through the day and seasons.

Since the tracking apparatus in the present embodiment, which comprises right ascension track 104, declination track 106, right ascension guide 108, and declination guide 110, only supports optical concentrator 102, and not solar radiation collection device 101, the cost of the tracking apparatus can be lowered with respect to conventional systems or conversely the solar radiation collection area can be increased for the same cost as compared to conventional CPV or Dish-Stirling systems. Also, since solar radiation collection device 101 is separate from optical concentrator 102, maintenance and part replacement for the system is easier and requires less disassembly. Furthermore, since solar radiation collection device 101 is stationary, heating and coolant fluids can be easily transported to it without requiring flexible joints or tubes that are prone to wear and fatigue under high temperatures, pressures and dynamic stresses.

The equatorial tracking system of the present embodiment permits the use of simple clock driven motors and generally eliminates the necessity for closed loop or microprocessor based controls due to the uniform variation in solar right ascension and solar declination during the sun's apparent motion through the day and the seasons. The equatorial tracking system also permits the use of independent clock based controls for diurnal and seasonal tracking permitting low budget applications where the seasonal declination of the sun can be tracked by means of a hand crank instead of a declination control system.

The non-axial rim drive system utilizing a worm drive of the present embodiment generally ensures a high mechanical advantage and enables the static torque and dynamic torque to be low compared to axis driven systems. The implementation of a worm drive actuated tracking motion generally ensures that step errors and drift errors of the right ascension and declination drives can be controlled or eliminated due to the ease of detection of whole rotations of the worm shaft corresponding to small fractional rotations of the trackers by simple electromechanical means as opposed to counting the lowest step increment of a stepper motor as is the case in the prior art. The worm drive actuated tracking motion also enables high accuracy due to a very large inherent gear ratio compared to axis driven systems.

It should be understood that the present embodiment provides dual axis equatorial solar tracking using polar-aligned rim drive motors 204 and 304 as described in the foregoing while maintaining a fixed point of convergence 516 of incident solar radiation. However, variations in the design to achieve this are understood to be within the scope of the invention. For example, without limitation, alternate embodiments of the present invention that result from any obvious changes in the application or method of use or operation, method of manufacture, shape, size, or material which are not specified within the detailed written description or illustrations are considered apparent or obvious to one skilled in the art are within the scope of the present invention. For example, without limitation, in some alternate embodiments, a hand crank can replace the declination drive motor, the right ascension drive motor or both. In other alternate embodiments, the rim drive systems may be driven by means other than a worm gear such as, but not limited to, other types of gear configurations, rollers, belt drives, pulleys etc.

Having fully described at least one embodiment of the present invention, other equivalent or alternative methods of providing solar radiation tracking and collection systems according to the present invention will be apparent to those skilled in the art. The invention has been described above by way of illustration, and the specific embodiments disclosed are not intended to limit the invention to the particular forms disclosed. For example, the particular application of the system may vary depending upon the particular type of solar radiation collection device used. The collection devices described in the foregoing were directed to electricity generating implementations; however, similar techniques are to provide solar radiation tracking and collection systems for various different applications such as, but not limited to, heating applications, lighting applications, etc. Implementations of the present invention used for applications other than generating electricity are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus for solar tracking and concentration of incident solar radiation for power generation, the apparatus comprising:
means for dual axis solar tracking along equatorial coordinates of a sun, using rim driven tracks;
means for concentrating the incident solar radiation into a stationary focal point, wherein said concentrating means is moved by said dual axis solar tracking means; and
means for coupling concentrated incident solar radiation to a power generation means.

2. The apparatus as recited in claim 1, further comprising means for guiding said rim driven tracks.

3 The apparatus as recited in claim 2, further comprising means for driving said rim driven tracks.

4. An apparatus for solar tracking and concentration of incident solar radiation for power generation, the apparatus comprising:
a solar tracking system for dual axis solar tracking along equatorial coordinates of a sun, said solar tracking system comprising a right ascension track having a rim and a declination track having a rim, wherein said right ascension track and said declination track are driven at their respective rims;
an optical concentrator system for concentrating the incident solar radiation into a stationary focal point, wherein said optical concentrator system is moved by said solar tracking system and said stationary focal point remains in a substantially fixed spatial location; and
a radiation collection device for coupling concentrated incident solar radiation to a power generation means, said radiation collection device disposed proximate said stationary focal point to collect the incident solar radiation.

5. The apparatus as recited in claim 4, wherein said optical concentrator system is joined to said right ascension track.

6. The apparatus as recited in claim 5, wherein said right ascension track forms an ascension arc with a center of curvature at said stationary focal point and said declination track forms a declination arc with a center of curvature at said stationary focal point.

7. The apparatus as recited in claim 6, further comprising a right ascension guide supporting said right ascension track and a declination guide supporting said declination track, wherein said right ascension guide is joined to said declination track.

8. The apparatus as recited in claim 7, wherein said right ascension track further comprising plurality of gear teeth for engaging worm shaft to drive said right ascension track for rotating said right ascension track in a right ascension plane.

9. The apparatus as recited in claim 8, wherein said declination track further comprising plurality of gear teeth for engaging worm shaft to drive said declination track for rotating said declination track in a declination plane.

10. The apparatus as recited in claim 5, wherein said right ascension track rotates about a right ascension axis, said declination track rotates about a declination axis, and said right ascension axis and said declination axis are perpendicular to each other and intersect within said stationary focal point.

11. The apparatus as recited in claim 7, wherein said right ascension track forms an arc large enough to track apparent diurnal motion of a sun and said right ascension track further comprises a partial annular disc with flanges on both of its flat surfaces, and a circular guide rail on both curved surfaces of the flange.

12. The apparatus as recited in claim 11, wherein said right ascension guide comprises two parallel flat plates with pairs of wheels for engaging with said circular guide rails of the said right ascension track.

13. The apparatus as recited in claim 7, wherein said declination track forms an arc large enough to track apparent seasonal motion of a sun and said declination track further comprises a partial annular disc with flanges on both of its flat surfaces, and a circular guide rail on both curved surfaces of the flange.

14. The apparatus as recited in claim 13, wherein said declination guide comprises two parallel flat plates with pairs of wheels for engaging with said circular guide rails of the said declination track.

15. The apparatus as recited in claim 4, wherein said radiation collection device couples heat to a power generator.

16. The apparatus as recited in claim 4, wherein said radiation collection device couples concentrated incident solar radiation to a photovoltaic cell array.

17. The apparatus as recited in claim 4, wherein said radiation collection device reflects concentrated incident solar radiation to a fixed location in space.

18. A method for solar tracking and concentration of incident solar radiation for power generation, the method comprising the steps of:
tracking a sun with a solar tracking system comprising a right ascension track having a rim and a declination track having a rim for dual axis solar tracking along equatorial coordinates of the sun, wherein said right ascension track and said declination track are driven at their respective rims during said tracking;
moving an optical concentrator system to concentrate the incident solar radiation into a stationary focal point, wherein said optical concentrator system is moved by the solar tracking system;
collecting concentrated incident solar radiation with a radiation collection device disposed proximate said stationary focal point; and
coupling concentrated incident solar radiation to a power generation means.

19. The method as recited in claim 18, wherein said coupling couples heat to a power generator.

20. The apparatus as recited in claim 18, wherein said coupling couples concentrated incident solar radiation to a photovoltaic cell array.

21. A method of making an apparatus for solar tracking and concentration of incident solar radiation for power generation, the method comprising:
configuring a solar tracking system to have a right ascension track and a declination track for dual axis solar tracking along equatorial coordinates of the sun such that the right ascension track and the declination track are driven at their respective rims;
configuring an optical concentrator system such that said optical concentrator system is moved by said solar tracking system to concentrate the incident solar radiation into a stationary focal point;
configuring a radiation collection device located at the stationary focal point such that said radiation collection device is capable of being independently supported without any mechanical linkage to said solar tracking system or said optical concentrator system, said radiation collection device being further configured to be coupled to a power generation device.
